(19) United States
(12) Patent Application Publication
(10) Pub. No.: US 2018/0284783 A1
(43) Pub. Date: Oct. 4, 2018

(54) AUTONOMOUS VEHICLE ROUTING BASED ON OCCUPANT CHARACTERISTICS

(71) Applicant: GM GLOBAL TECHNOLOGY OPERATIONS LLC, Detroit, MI (US)

(72) Inventors: Robert B. COOLEY, Ann Arbor, MI (US); Cody D. BERMAN, Ann Arbor, MI (US)

(21) Appl. No.: 15/475,443

(22) Filed: Mar. 31, 2017

(51) Int. Cl. G05D 1/02; G01C 21/34; B60W 10/20; B60W 10/18; B60W 10/04; B60W 10/10; G05D 1/00; B60W 50/10

(52) U.S. Cl. CPC G05D 1/0212; G01C 21/3461; G01C 21/3469; B60W 10/20; B60W 10/18; G01S 19/13; B60W 10/10; G05D 1/0088; G01C 21/3484; B60W 50/10; G05D 1/0276; B60W 10/04

(57) ABSTRACT

A method of controlling a vehicle having an automated driving system includes, in response to receiving a drive cycle destination from a user, determining a first route from a current vehicle location to the drive cycle destination and a second route from the current vehicle location to the drive cycle destination. The first route is distinct from the second route. The method additionally includes determining whether a user criterion is satisfied. The method further includes automatically controlling the vehicle to the drive cycle destination according to the first route in response to the user criterion being satisfied, or according to the second route in response to the user criterion not being satisfied.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

A method of controlling a vehicle having an automated driving system according to the present disclosure includes, in response to receiving a drive cycle destination from a user, determining a first route from a current vehicle location to the drive cycle destination and a second route from the current vehicle location to the drive cycle destination. The first route is distinct from the second route. The method additionally includes determining whether a user criterion is satisfied. The method further includes automatically controlling the vehicle to the drive cycle destination according to the first route in response to the user criterion being satisfied, or according to the second route in response to the user criterion not being satisfied.

In an exemplary embodiment, the user criterion includes a number of vehicle occupants. In such embodiment, the first route includes a high-occupancy vehicle lane.

In an exemplary embodiment, the user criterion includes a geolocation authorization. In such embodiments, the first route includes a driving surface within the geolocation.

In an exemplary embodiment, the user criterion includes a roadway class preference. In such embodiments, the first route includes a preferred roadway class.

In an exemplary embodiment, the user criterion includes a toll road payment authorization. In such embodiments, the first route includes a toll road.

A vehicle according to the present disclosure includes an actuator configured to control vehicle steering, acceleration, braking, or shifting. The vehicle additionally includes at least one controller. The controller is configured to automatically control the actuator based on an automated driving system algorithm. The controller is configured to receive a drive cycle destination from a user, and determine a first route from a current vehicle location to the drive cycle destination and a distinct second route from the current vehicle location to the drive cycle destination. The controller is also configured to determine whether a user criterion is satisfied, and control the vehicle via the automated driving system algorithm to the drive cycle destination according to the first route in response to the user criterion being satisfied, or according to the second route in response to the user criterion not being satisfied.

In an exemplary embodiment, the user criterion includes a number of vehicle occupants. In such embodiment, the first route includes a high-occupancy vehicle lane.

In an exemplary embodiment, the user criterion includes a geolocation authorization. In such embodiments, the first route includes a driving surface within the geolocation.

In an exemplary embodiment, the user criterion includes a roadway class preference. In such embodiments, the first route includes a preferred roadway class.

In an exemplary embodiment, the user criterion includes a toll road payment authorization. In such embodiments, the first route includes a toll road.

A method of controlling a vehicle having an automated driving system according to the present disclosure includes, in response to receiving a drive cycle destination from a user, selecting a target vehicle from among a vehicle fleet. The target vehicle has a current vehicle location. The method additionally includes determining a first route from the current vehicle location to the drive cycle destination. The method also includes determining whether a user criterion is satisfied and determining whether a vehicle capability criterion is satisfied. The method further includes controlling the target vehicle, via the automated driving system, to the drive cycle destination according to the first route in response to the user criterion being satisfied and the vehicle capability criterion being satisfied, and in response to the user criterion not being satisfied or the vehicle capability criterion being satisfied, selecting an alternate vehicle from among the vehicle fleet or determining a second distinct route from the current vehicle location to the drive cycle destination.

In an exemplary embodiment, the user criterion includes a number of vehicle occupants. In such embodiment, the first route includes a high-occupancy vehicle lane.

In an exemplary embodiment, the user criterion includes a geolocation authorization. In such embodiments, the first route includes a driving surface within the geolocation.

In an exemplary embodiment, the user criterion includes a roadway class preference. In such embodiments, the first route includes a preferred roadway class.

In an exemplary embodiment, the user criterion includes a toll road payment authorization. In such embodiments, the first route includes a toll road.

In an exemplary embodiment, the vehicle capability requirement includes an electric operation requirement.

In an exemplary embodiment, the vehicle capability requirement includes a vehicle range.

Embodiments according to the present disclosure provide a number of advantages. For example, the present disclosure provides a system and method for optimizing a vehicle route for an autonomous vehicle according to preferences, characteristics, and credentials of a user or users within the vehicle.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic view of a vehicle according to the present disclosure;

FIG. 2 is a schematic representation of a system for controlling a vehicle according to the present disclosure;

FIG. 3 is a flowchart representation of a method according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

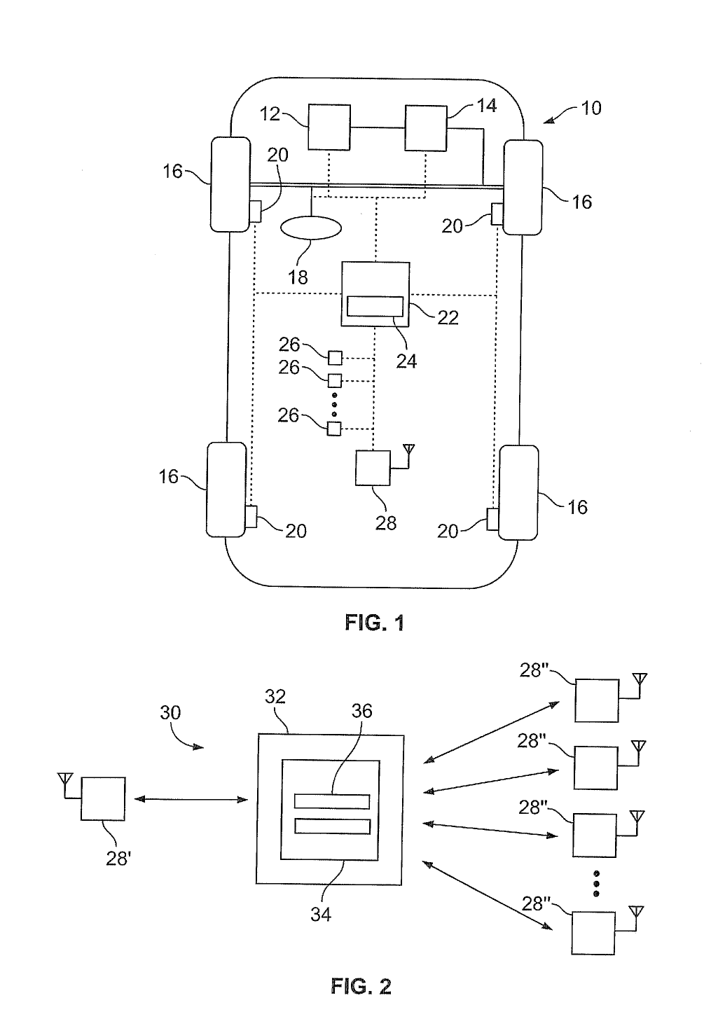

Referring now to FIG. 1, an automotive vehicle 10 according to the present disclosure is shown in schematic form. The automotive vehicle 10 includes a propulsion system 12, which may in various embodiments include an internal combustion engine, an electric machine such as a traction motor, and/or a fuel cell propulsion system.

The automotive vehicle 10 also includes a transmission 14 configured to transmit power from the propulsion system 12 to vehicle wheels 16 according to selectable speed ratios. According to various embodiments, the transmission 14 may include a step-ratio automatic transmission, a continuously-variable transmission, or other appropriate transmission.

The automotive vehicle 10 additionally includes a steering system 18. While depicted as including a steering wheel for illustrative purposes, in some embodiments contemplated within the scope of the present disclosure, the steering system 18 may not include a steering wheel.

The automotive vehicle 10 additionally includes a plurality of vehicle wheels 16 and associated wheel brakes 20 configured to provide braking torque to the vehicle wheels 16. The wheel brakes 20 may, in various embodiments, include friction brakes, a regenerative braking system such as an electric machine, and/or other appropriate braking systems.

The propulsion system 12, transmission 14, steering system 18, and wheel brakes 20 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 is provided with an automated driving system (ADS) 24 for automatically controlling various actuators in the vehicle 10. In an exemplary embodiment, the ADS 24 is configured to control the propulsion system 12, transmission 14, steering system 18, and wheel brakes 20 to control vehicle acceleration, steering, and braking, respectively, without human intervention.

The ADS 24 is configured to control the propulsion system 12, transmission 14, steering system 18, and wheel brakes 20 in response to inputs from a plurality of sensors 26, which may include GPS, RADAR, LIDAR, optical cameras, thermal cameras, ultrasonic sensors, and/or additional sensors as appropriate.

The vehicle 10 additionally includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. However, aspects of the present disclosure may be implemented in vehicles having lower-level automated driving systems.

Referring now to FIG. 2, an embodiment of a system 30 for controlling a vehicle is shown. The system 30 includes a wireless communication device 28′. In an exemplary embodiment, the wireless communication device 28′ is associated with an autonomous vehicle arranged generally similar to the vehicle 10 as shown in FIG. 1 and discussed above.

The wireless communication device 28′ is in communication with at least one remote server 32. In an exemplary embodiment, the wireless communication device 28′ is configured to wirelessly communicate with the server 32, e.g. via cellular data communication or other appropriate wireless communication protocols.

The wireless communication device 28″ is configured to communicate information to the server 32. The server 32 includes at least one computer readable storage device 34. The server 32 may include a microprocessor or central processing unit (CPU) in communication with the computer readable storage device 34. The computer readable storage device 34 is provided with data 36, e.g. in the form of one or more databases, including a traffic control device database having a list of known traffic control devices and associated intersection positions.

In an exemplary embodiment, the data 36 includes a secure user profile database for storing various information associated with one or more users, such as billing information for paying fares or tolls, route preferences as will be discussed in further detail below, and geolocation authorization information. The geolocation authorization information includes an authorization for a given user to enter a restricted roadway. As an example, a resident of a restricted or gated community may have a community access authorization associated with the resident's user account. The community access authorization indicates that the resident is authorized to traverse roadways within the community. As another example, an employee of a business may have a campus access authorization associated with the employee's user account. The campus access authorization indicates that the employee is authorized to traverse roadways within the business's campus. In some embodiments, geolocation authorization information may be regulated and issued by the entity responsible for the restricted roadway, such as the community homeowner association or business in the examples above. In other embodiments, a user may self-declare an authorization to enter a restricted roadway.

A plurality of additional wireless communication devices 28″ are also in communication with the server 32. The additional wireless communication devices 28″ are configured to receive information from the server 32, e.g. by accessing the databases 36 or by having information “pushed” from the server 32 to the additional wireless communication devices 28″. In an exemplary embodiment, the plurality of additional wireless communication devices 28″ are coupled to a plurality of additional vehicles.

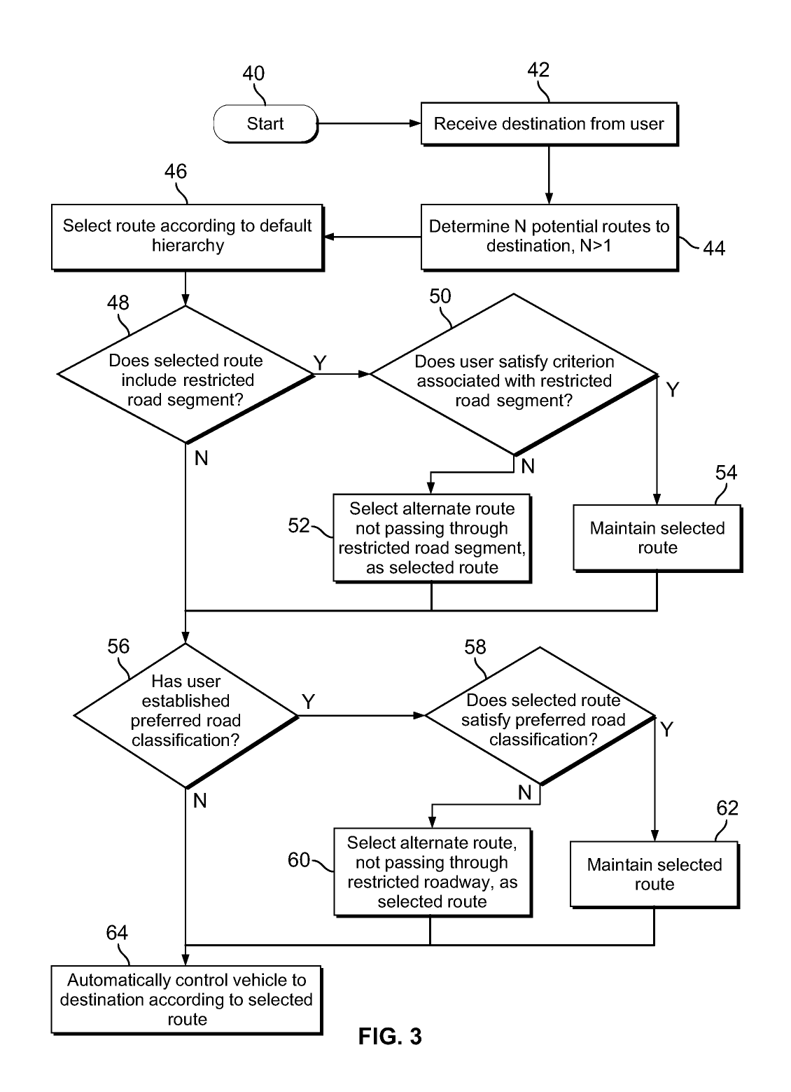

Referring now to FIG. 3, a method of controlling a vehicle according to the present disclosure is illustrated in flowchart form. The algorithm begins at block 40.

A destination is received from a user, as illustrated at block 42. The user may be an occupant of the vehicle selecting a destination for drop-off, an entity external to the vehicle selecting a location for pick-up, or other use cases as appropriate. The destination indicates a desired destination for a current drive cycle or a portion thereof.

A plurality N of potential routes to the destination is then determined, as illustrated at block 44. The potential routes each include one or more road segments between a current location of the vehicle and the destination received in block 42. The potential routes are distinguishable from one another based on the road segments or combination thereof associated with each potential route. A road segment may refer to a given street or highway, and may also refer to a specific lane within a multi-lane street or highway. Some road segments may be freely traversed by any vehicle, such as public highways, while some road segments may be subject to one or more restrictions, as will be discussed in further detail below.

A selected route from among the N potential routes is determined according to a default prioritization schema, as illustrated at block 46. The default prioritization schema may determine the selected route to minimize energy consumption, minimize travel time, or any other schema as appropriate using known routing techniques.

A determination is made of whether the selected route includes a restricted road segment, as illustrated at operation 48. A restricted road segment refers to a road segment for which a vehicle or occupant must comply with at least one criterion to obtain authorization to drive on the road segment. The criterion may be a regulatory criterion, e.g. a minimum occupancy rule for a high-occupancy vehicle lane. The criterion may also be a premises authorization criterion, e.g. a requirement of employee status for a business campus or a requirement of residency for a gated community.

If the determination of operation 48 is positive, i.e. the selected route does include a restricted road segment, then control proceeds to operation 50. At operation 50, a determination is made of whether the user or vehicle satisfies the criterion associated with the restricted road segment.

As an example, if the restricted road segment includes a high-occupancy vehicle lane, then a determination is made of whether a current total number of vehicle occupants satisfies a minimum occupancy rule for the high-occupancy vehicle lane. This may be performed using known techniques for occupant sensing based on inputs from a variety of sensors such as pressure transducers, internal thermal imaging, and internal optical cameras.

As another example, if the restricted road segment includes restricted premises such as a business campus or a secured neighborhood road, then a determination is made of whether the user is authorized to enter the premises. In an exemplary embodiment, this determination includes consulting a user profile database to evaluate whether the user is provided with geolocation authorization information for the restricted premises, as discussed above with respect to FIG. 2.

As yet another example, if the restricted road segment includes a toll road, then a determination is made of whether the user has authorized the payment of tolls, e.g. by consulting a user profile database to evaluate whether the user has provided toll payment information, as discussed above with respect to FIG. 2.

In an exemplary embodiment, if multiple occupants are within the vehicle, then the determination of operation 50 is satisfied only if all occupants satisfy the user criterion associated with the restricted road segment.

If the determination of operation 50 is negative, i.e. the user or vehicle does not satisfy the criterion associated with the restricted road segment, then an alternate route is selected as the selected route, as illustrated at block 52. In an exemplary embodiment, the alternate route is the highest ranked potential route from the prioritization schema of block 46 which does not pass through the restricted road segment. However, in other embodiments, other rerouting techniques may be implemented. Control then proceeds to operation 56, as will be discussed in further detail below.

If the determination of operation 50 is positive, then the selected route from block 46 is maintained, as illustrated at block 54. Control then proceeds to operation 56, as will be discussed in further detail below.

Returning to operation 48, if the determination is negative, i.e. the selected route does not include a restricted road segment, then control proceeds to operation 56.

At operation 56, a determination is made of whether the user has established a preferred road classification. In an exemplary embodiment, a preferred road classification may be established by a user via, for example, a mobile device interface and subsequently stored with a user profile. The preferred road classification may include, for example, a preference to avoid highways, or a preference for scenic roadways.

If the determination of operation 56 is positive, i.e. a user has established a preferred road classification, then control proceeds to operation 58. At operation 58, a determination is made of whether the selected route satisfies the preferred road classification.

As an example, if the user has established a preference to avoid highways, then a determination is made of whether the selected route satisfies the preference to avoid highways, e.g. includes only surface roads.

As another example, if the user has established a preference for scenic roadways, then a determination is made of whether the selected route satisfies the preference for scenic roadways, e.g. by utilizing roads designated by the United States National Scenic Byways Program or similar program.

In an exemplary embodiment, if multiple occupants are within the vehicle, then the determination of operation 58 is satisfied by arbitrating among the multiple occupants' preferences.

If the determination of operation 58 is negative, i.e. the selected route does not satisfy the preferred road classification, then an alternate route is selected as the selected route, as illustrated at block 60. In an exemplary embodiment, the alternate route is the highest ranked potential route from the prioritization schema of block 46 which satisfies the preferred road classification. However, in other embodiments, other rerouting techniques may be implemented. Control then proceeds to block 64, as will be discussed in further detail below.

If the determination of operation 58 is positive, i.e. the selected route does satisfy the preferred road classification, then the selected route is maintained, as illustrated at block 62. Control then proceeds to block 64, as will be discussed in further detail below.

Returning to operation 56, if the determination is negative, i.e. the user has not established a preferred road classification, then control proceeds to block 64.

At block 64, the vehicle is controlled to the destination, via the automated driving system, in accordance with the selected route.

Methods according to the present disclosure may also be used to control a fleet of autonomous vehicles, in addition to routing individual vehicles. A central server, e.g. similar to the server 32 illustrated in FIG. 2, may receive a request from a user, including a drive cycle destination. The central server may identify a target vehicle to satisfy the request. In addition to evaluating user criteria associated with the route as discussed above with respect to FIG. 3, the central server may also evaluate vehicle criteria associated with the target vehicle and the route. As an example, in some geographic locations, operation of internal combustion engines may be restricted or prohibited. For routes passing through such locations, the vehicle criteria may include a vehicle capability for operation in electric-only mode. As another example, the vehicle criteria may include current operation range of the target vehicle. For routes having a total driving distance exceeding the current operating range, the vehicle criteria associated with the target vehicle and the route may not be satisfied. In response to determining that the target vehicle does not satisfy the vehicle criteria, the central server may select and dispatch an alternate vehicle to convey the user and/or select an alternate route to the drive cycle destination.

As may be seen the present disclosure provides a system and method for operating an autonomous vehicle in accordance with preferences, characteristics, and credentials of users, thereby increasing user satisfaction. Autonomous vehicles may thereby traverse otherwise restricted routes in order to pick up or drop off authorized passengers.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A method of controlling a vehicle having an automated driving system, the method comprising:
in response to receiving a drive cycle destination from a user, determining a first route from a current vehicle location to the drive cycle destination and a second route from the current vehicle location to the drive cycle destination, the first route being distinct from the second route;
determining whether one or more user criteria associated with a user profile of a vehicle user is satisfied, the one or more user criteria including a geolocation authorization associated with a restricted driving surface; and
controlling the vehicle, via the automated driving system, to the drive cycle destination according to the first route in response to the user criterion being satisfied or according to the second route in response to the user criterion not being satisfied, wherein the first route includes the restricted driving surface.

2. The method of claim 1, wherein the one or more user criteria include a number of vehicle occupants, and wherein the first route includes a high-occupancy vehicle lane.

3. (canceled)

4. The method of claim 1, wherein the one or more user criteria include a roadway class preference, and wherein the first route includes a preferred roadway class.

5. The method of claim 1, wherein the one or more user criteria include a toll road payment authorization, and wherein the first route includes a toll road.

6. A vehicle comprising:
an actuator configured to control vehicle steering, acceleration, braking, or shifting; and
at least one controller configured to automatically control the actuator based on an automated driving system algorithm, the at least one controller being configured to receive a drive cycle destination from a user, determine a first route from a current vehicle location to the drive cycle destination and a distinct second route from the current vehicle location to the drive cycle destination, determine whether one or more user criteria associated with a user profile of a vehicle user is satisfied, the one or more user criteria including a geolocation authorization associated with a restricted driving surface, and control the vehicle via the automated driving system algorithm to the drive cycle destination according to the first route in response to the user criterion being satisfied or according to the second route in response to the user criterion not being satisfied, wherein the first route includes the restricted driving surface and the second route does not include the restricted driving surface.

7. The vehicle of claim 6, wherein the one or more user criteria include a number of vehicle occupants, and wherein the first route includes a high-occupancy vehicle lane.

8. (canceled)

9. The vehicle of claim 6, wherein the one or more user criteria include a roadway class preference, and wherein the first route includes a preferred roadway class.

10. The vehicle of claim 6, wherein the one or more user criteria include a toll road payment authorization, and wherein the first route includes a toll road.

11. A method of controlling a vehicle having an automated driving system, the method comprising:
in response to receiving a drive cycle destination from a user, selecting a target vehicle from among a vehicle fleet, the target vehicle having a current vehicle location;
determining a first route from the current vehicle location to the drive cycle destination;
determining whether one or more user criteria associated with a user profile of a vehicle user is satisfied, the one or more user criteria including a geolocation authorization associated with a restricted driving surface;
determining whether a vehicle capability criterion is satisfied; and
controlling the target vehicle, via the automated driving system, to the drive cycle destination according to the first route in response to the user criterion being satisfied and the vehicle capability criterion being satisfied, wherein the first route includes the restricted driving surface and the second route does not include the restricted driving surface, and in response to the user criterion not being satisfied or the vehicle capability criterion not being satisfied, selecting an alternate vehicle from among the vehicle fleet or determining a second distinct route from the current vehicle location to the drive cycle destination.

12. The method of claim 11, wherein the one or more user criteria include a number of vehicle occupants, and wherein the first route includes a high-occupancy vehicle lane.

13. (canceled)

14. The method of claim 11, wherein the one or more user criteria include a roadway class preference, and wherein the first route includes a preferred roadway class.

15. The method of claim 11, wherein the one or more user criteria include a toll road payment authorization, and wherein the first route includes a toll road.

16. The method of claim 11, wherein the vehicle capability criterion includes an electric operation requirement.

17. The method of claim 11, wherein the vehicle capability criterion includes a vehicle range.

18. The method of claim 1, wherein the geolocation authorization is regulated and issued by an entity responsible for the restricted driving surface.

19. The vehicle of claim 6, wherein the geolocation authorization is regulated and issued by an entity responsible for the restricted driving surface.

20. The method of claim 11, wherein the geolocation authorization is regulated and issued by an entity responsible for the restricted driving surface.
